(19) United States
(12) Patent Application Publication
(10) Pub. No.: US 2023/0184024 A1
(43) Pub. Date: Jun. 15, 2023

(54) DEVICE AND METHOD FOR CONTROLLING DOOR OF VEHICLE

(71) Applicants: Hyundai Motor Company, Seoul (KR); Kia Corporation, Seoul (KR)

(72) Inventor: Min Gu Park, Gyeonggi-do (KR)

(21) Appl. No.: 17/939,737

(22) Filed: Sep. 7, 2022

(30) Foreign Application Priority Data
Dec. 14, 2021 (KR) 10-2021-0178965

(51) Int. Cl. E05F 15/73; B60R 1/20; E05B 81/76

(52) U.S. Cl. CPC E05F 15/73; B60R 1/20; E05B 81/77; E05F 2015/765; E05F 2015/767

(57) ABSTRACT

The present disclosure relates to a device and a method for controlling a door of a vehicle. The device includes two or more doors for opening an interior of the vehicle, a position sensing device for sensing an object outside the vehicle, and a controller that activates the position sensing device based on user authentication, determines a position of a user when the object sensed by the position sensing device is the user, and performs control to open a door corresponding to the position of the user.

### CROSS-REFERENCE TO RELATED APPLICATION

This application is based on and claims under 35 U.S.C. § 119(a) the benefit of Korean Patent Application No. 10-2021-0178965, filed in the Korean Intellectual Property Office on Dec. 14, 2021, the entire contents of which are incorporated herein by reference.

### TECHNICAL FIELD

Embodiments of the present disclosure relate to a device and a method for controlling a door of a vehicle, and more particularly, to a technology capable of increasing safety of a user while increasing convenience.

### BACKGROUND

A scheme of controlling a door of a vehicle using a smart key is becoming common. When the door of the vehicle is opened using the smart key, doors corresponding to all seats including a passenger seat other than a driver's seat are opened. Because of a characteristic that all of the doors are opened by a driver, there may be a problem of becoming a target of theft, robbery, or the like that invades the vehicle.

To prevent such a problem, a smart key that controls only a door adjacent to the driver's seat to be opened and control other doors not to be opened has appeared.

However, there is still a problem in that all of the doors must be opened as in the prior art for a user to open a door corresponding to another seat or a tailgate rather than for a purpose of boarding the driver's seat. In particular, in a state in which both hands of the user are not free because the user is carrying a stuff, it may be more difficult to open only a desired door.

### SUMMARY

The present disclosure has been made to solve the above-mentioned problems occurring in the prior art while advantages achieved by the prior art are maintained intact.

An exemplary embodiment of the present disclosure provides a device and a method for controlling a door of a vehicle that may ensure user safety of the vehicle while remotely adjusting the door of the vehicle.

Another exemplary embodiment of the present disclosure provides a device and a method for controlling a door of a vehicle that may open only a door desired by a user such that the user may move a stuff more easily even when both hands are not free because of carrying the stuff or the like.

The technical problems to be solved by the present disclosure are not limited to the aforementioned problems, and any other technical problems not mentioned herein will be clearly understood from the following description by those skilled in the art to which the present disclosure pertains.

In one aspect, a device for controlling a door of a vehicle is provided, the device comprising: a) a position sensing device configured to sense an object outside the vehicle; b) an authentication camera configured to perform the user authentication; and c) a controller configured to: i) activate the position sensing device based on user authentication; b) determine a position of a user when the object sensed by the position sensing device is the user; and c) open a door of the vehicle corresponding to the position of the user.

According to an exemplary embodiment of the present disclosure, a device for controlling a door of a vehicle includes two or more doors for opening an interior of the vehicle, a position sensing device for sensing an object outside the vehicle, and a controller that activates the position sensing device based on user authentication, determines a position of a user when the object sensed by the position sensing device is the user, and performs control to open a door corresponding to the position of the user.

In one implementation, the device may further include a first authentication camera for filming an exterior image of the vehicle at regular intervals to perform the user authentication.

In one implementation, the controller may extract the object from the exterior image acquired through the first authentication camera, and determine whether the object corresponds to a pre-stored user image.

In one implementation, the controller may determine a gesture of the object based on the consecutive exterior images, and determine whether the gesture corresponds to a pre-stored pattern.

In one implementation, the controller may determine a movement of the user based on the consecutive exterior images, and activate the position sensing device located on a side where the user has moved to.

In one implementation, the device may further include a second authentication camera for retrying the user authentication when the user authentication fails, and the second authentication camera may be disposed in a direction perpendicular to a direction of the first authentication camera.

In one implementation, the second authentication camera may be located on a side of the vehicle, and the controller may activate the position sensing device positioned on the same side as the second authentication camera performed the user authentication retry.

In one implementation, the position sensing device may be ultrasonic sensors corresponding to each of the doors.

In one implementation, the position sensing device may be a side view monitoring camera of the vehicle.

In one implementation, the controller may open the door after performing additional user authentication using a second authentication camera disposed in a direction perpendicular to a direction of the first authentication camera.

According to another exemplary embodiment of the present disclosure, a method for controlling a door of a vehicle includes activating a position sensing device based on user authentication, determining a position of a user located outside the vehicle using the activated position sensing device, and opening a door corresponding to the position of the user.

In one implementation, the activating of the position sensing device may include filming an exterior image of the vehicle at regular intervals, and performing the user authentication based on an object extracted from the exterior image.

In one implementation, the performing of the user authentication may include determining whether the object corresponds to a pre-stored user image.

In one implementation, the performing of the user authentication may include determining a gesture of the object, and determining whether the gesture of the object corresponds to a pre-stored pattern.

In one implementation, the activating of the position sensing device may include determining a movement of the user based on the consecutive exterior images, and activating the position sensing device located on a side where the user has moved to.

In one implementation, the performing of the user authentication may include trying the user authentication based on the exterior image acquired through a first authentication camera disposed in a first direction of the vehicle, and retrying the user authentication using a second authentication camera disposed in a direction perpendicular to the first direction when the user authentication fails.

In one implementation, the second authentication camera may be located on a side of the vehicle, and the activating of the position sensing device may include activating the position sensing device positioned on the same side as the second authentication camera acquired the image where the object is detected in the user authentication retry procedure.

In one implementation, the determining of the position of the user may include using ultrasonic sensors corresponding to each of the doors of the vehicle.

In one implementation, the determining of the position of the user may include using a side view monitoring camera of the vehicle.

In one implementation, the opening of the door may include performing the user authentication using a first authentication camera disposed in a first direction of the vehicle, performing additional user authentication using a second authentication camera disposed in a direction perpendicular to the direction of the first authentication camera, and opening the door based on the additional user authentication.

As discussed, the method and system suitably include use of a controller or processer.

In another embodiment, vehicles are provided that comprise an apparatus or device as disclosed herein.

### BRIEF DESCRIPTION OF THE DRAWINGS

The above and other objects, features and advantages of the present disclosure will be more apparent from the following detailed description taken in conjunction with the accompanying drawings:

FIG. 1 is a view showing a vehicle including a door control device of the vehicle according to an embodiment of the present disclosure;

FIG. 2 is a block diagram showing a configuration of a door control device of a vehicle;

FIG. 3 is a flowchart for illustrating a door control method according to an embodiment of the present disclosure;

FIG. 4 is a flowchart illustrating a method for activating a position sensing device according to an embodiment of the present disclosure;

FIG. 5 is a view for illustrating a method for trying user authentication based on an exterior image acquired from a built-in cam;

FIG. 6 is a view for illustrating an embodiment of performing user authentication based on a gesture of an object;

FIG. 7 is a view illustrating an embodiment of notifying that user authentication is successful through an external display;

FIG. 8 is a view for illustrating a method for determining a user movement;

FIG. 9 is a view for illustrating an embodiment of determining a position of a user;

FIG. 10 is a flowchart illustrating a door control method according to another embodiment of the present disclosure;

FIG. 11 is a view for illustrating an additional user authentication procedure; and

FIG. 12 is a diagram illustrating a computing system according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

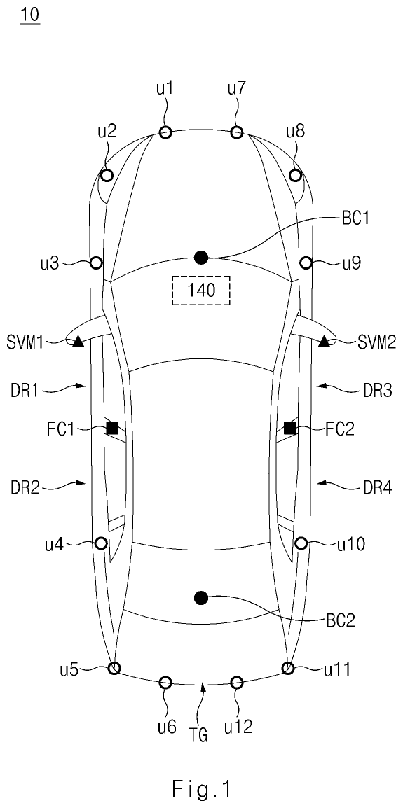

Hereinafter, embodiments of the present disclosure will be described in detail with reference to FIGS. 1 to 11.

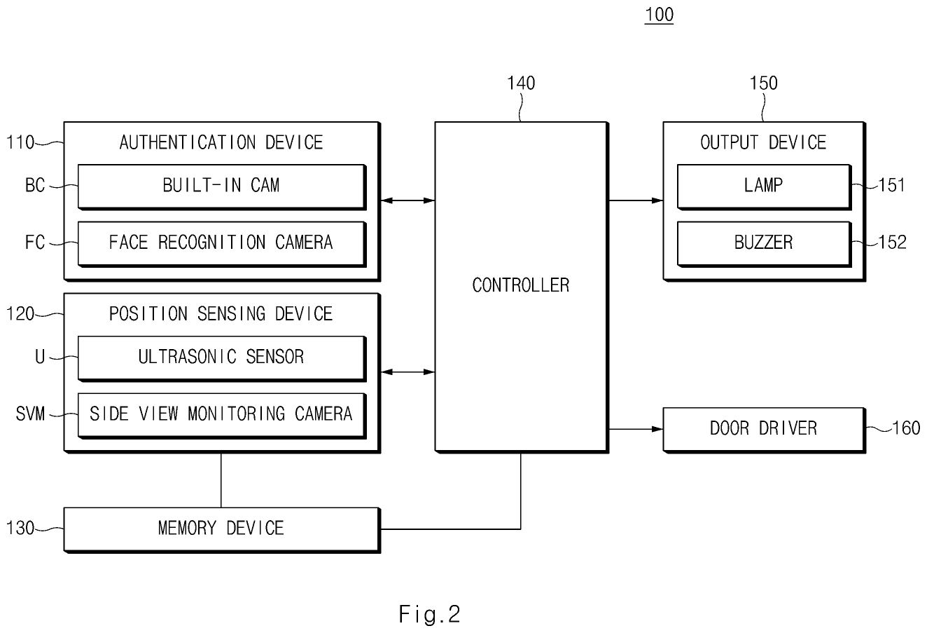

FIG. 1 is a view showing a vehicle including a door control device of the vehicle according to an embodiment of the present disclosure. FIG. 2 is a block diagram showing a configuration of a door control device of a vehicle. A door referred to in the embodiment of the present disclosure may collectively refer to means for opening an interior of a vehicle, and may collectively refer to a door adjacent to a seat on a side surface of the vehicle and a tailgate that opens a loading space at a rear portion of the vehicle. Hereinafter, the present specification shows a door control device implemented in a vehicle having first to fourth doors DR1 to DR4 and a tailgate TG as shown in FIG. 1.

Referring to FIGS. 1 and 2, a door control device 100 of the vehicle according to an embodiment of the present disclosure may include an authentication device 110, a position sensing device 120, a memory device 130, a controller 140, an output device 150, and a door driver 160.

According to an embodiment of the present disclosure, the authentication device 110, which is for performing user authentication, may include a built-in cam BC for acquiring an exterior image of the vehicle and a face recognition camera FC.

The built-in cam BC may be disposed at a front portion or the rear portion of the vehicle to acquire an exterior image for a region in front of the vehicle or an exterior image for a region at the rear of the vehicle. The built-in cam BC may be always activated based on user setting, and may acquire the exterior image at regular intervals. The built-in cam BC may be a black box for the vehicle. When the built-in cam BC is a two-channel black box, the built-in cam BC may include the first built-in cam BC1 disposed at the front portion of the vehicle and the second built-in cam BC2 disposed at the rear portion of the vehicle.

The built-in cam BC according to an embodiment of the present disclosure, which is for acquiring the exterior image for the user authentication, may be referred to as a first authentication camera. The built-in cam BC may be disposed in at least one of a front or rear of the vehicle.

The face recognition camera FC, which is for acquiring an image for user identification, may be disposed in a direction perpendicular to that of the built-in cam BC. According to the embodiment, the face recognition camera FC may be disposed in a lateral direction of the vehicle, and may include a first face recognition camera FC1 disposed on a left side and a second face recognition camera FC2 disposed on a right side. The face recognition camera FC may be mounted on a B-pillar of the vehicle. The face recognition camera FC, which is for assisting user authentication means of the built-in cam BC, may be referred to as a second authentication camera.

The face recognition camera FC may be activated under certain conditions to prevent a battery of the vehicle from being discharged. The face recognition camera FC according to an embodiment of the present disclosure may maintain a turn-off state, and may be activated under control of the controller 140. For example, the face recognition camera FC may be activated based on the controller 140 determining an additional user authentication operation.

According to an embodiment of the present disclosure, the position sensing device 120, which is for determining a position of an object, may include a side view monitoring camera SVM and an ultrasonic sensor U.

The side view monitoring camera SVM, which is for acquiring an exterior image for the lateral direction of the vehicle, may include a first side view monitoring camera SVM1 disposed on the left side and a second side view monitoring camera SVM2 disposed on the right side. The side view monitoring camera SVM may use a wide-angle camera to acquire an image of a wide range in the lateral direction of the vehicle. For example, the first side view monitoring camera SVM1 may acquire an image of regions in front of the first door DR1 and the second door DR2.

The ultrasonic sensor U may include a plurality of ultrasonic sensors to correspond to the doors, and two or more ultrasonic sensors may correspond to one door. The embodiment of the present disclosure shows the door control device 100 implemented with first to twelfth ultrasonic sensors U1 to U12. Each ultrasonic sensor may be matched with the one closest door. For example, the first to third ultrasonic sensors U1 to U3 may correspond to the first door DR1, the fourth and fifth ultrasonic sensors U4 and U5 may correspond to the second door DR2, the sixth and twelfth ultrasonic sensors U6 and U12 may correspond to the tailgate TG, the seventh to ninth ultrasonic sensors U7 to U9 may correspond to the third door DR3, and the tenth and eleventh ultrasonic sensors U10 and U1 1 may correspond to the fourth door DR4.

The ultrasonic sensor U may be activated under certain conditions to prevent the battery of the vehicle from being discharged. The ultrasonic sensor U according to an embodiment of the present disclosure may maintain the turn-off state, and may be activated under the control of the controller 140. For example, the ultrasonic sensor U may be activated in an operation in which the controller 140 determines a position of a user.

The memory device 130 may provide a space in which a user image for the user authentication may be stored. In addition, the memory device 130 may provide a space in which an overall operation algorithm of the controller 140 is stored and a space in which an AI processor is stored. The memory device 130 may be disposed in the controller 140, and may be disposed independently of the controller 140. The memory device 130 may be a combination of a non-volatile memory such as a hard disk drive, a flash memory, an electrically erasable programmable read-only memory (EEPROM), a static RAM (SRAM), a ferro-elec ic RAM (FRAM), a phase-change RAM (PRAM), a magnetic RAM (MRAM), and the like and/or a volatile memory such as a dynamic random access memory (DRAM), a synchronous dynamic random access memory (SDRAM), a double date rate-SDRAM (DDR-SDRAM), and the like.

The controller 140 may activate the position sensing device 120 based on the user authentication, determine the position of the user when the object sensed by the position sensing device 120 is the user, and perform control to open a door corresponding to the position of the user.

In addition, the controller 140 may perform artificial intelligence learning based on the artificial intelligence (hereinafter, AI) processor for the user authentication. The AI processor may learn a neural network using a pre-stored program. A neural network for the user authentication may be designed to simulate a human brain structure on a computer, and may include a plurality of network nodes having weights that simulate neurons of a human neural network. The plurality of network nodes may transmit and receive data based on a connection relationship therebetween such that the neuron simulates a synaptic activity of the neuron that transmits and receives a signal through synapse. The neural network may include a deep learning model developed from a neural network model. In the deep learning model, the plurality of network nodes may exchange the data based on a convolutional connection relationship while being located in different layers. Examples of the neural network models may include various deep learning techniques such as a deep neural network (DNN), a convolutional deep neural network (CNN), a recurrent neural network (RNN), a restricted Boltzmann machine (RBM), a deep belief network (DBN), and a deep Q-network.

The output device 150 may guide a user authentication procedure or guide a user authentication result. The output device 150 may include a lamp 151, a buzzer 152, and an external display 153.

The lamp 151 may emit light so as to be identified from the outside of the vehicle, and the number of light emission or a light emission pattern may vary depending on information to be guided.

The bu77er 152 may ring so as to be heard from the outside of the vehicle, and the number of ringing or a ringing pattern may vary depending on the information to be guided.

The external display 153 may be a device for displaying an image to the user located outside the vehicle. The external display 153 may be a head-up display (HUD) that displays the image in a window inside the vehicle or a touch display formed in the window of the vehicle.

The door driver 160 may open the doors under the control of the controller 140.

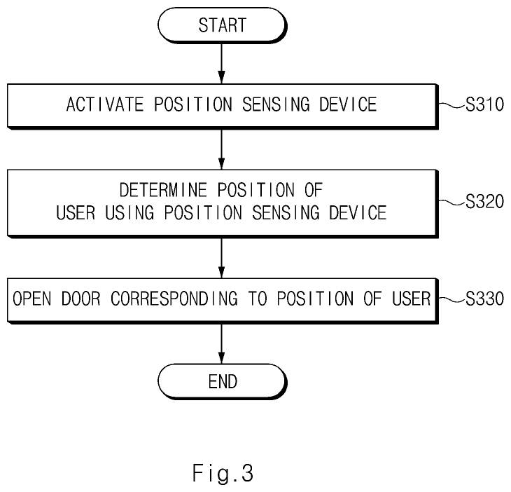

Hereinafter, a door control method according to an embodiment of the present disclosure will be described in detail. FIG. 3 is a flowchart for illustrating a door control method according to an embodiment of the present disclosure.

Referring to FIG. 3, the door control method according to the embodiment of the present disclosure may activate the position sensing device 120 in a first operation (S310). The first operation (S310) may be a procedure performed in a state in which the vehicle is turned off and all of the doors DR1 to DR4 and TG of the vehicle are closed.

The position sensing device 120 may be activated based on the user authentication. The user may be an owner of the vehicle, or may be a person who is permitted to control the door of the vehicle by the owner of the vehicle. According to the embodiment of the present disclosure, the user authentication may be performed based on the exterior image of the vehicle acquired through the authentication device 110.

In a second operation (S320), the position of the user may be determined using the activated position sensing device 120.

According to one embodiment, the controller 140 may acquire the exterior image in the lateral direction of the vehicle through the side view monitoring camera, and identify the position of the user identified in the exterior image. When the user is not detected in the image acquired through the side view monitoring camera, the controller 140 may estimate that the user is located in front of the tailgate TG.

According to another embodiment, the controller 140 may operate the ultrasonic sensors corresponding to the doors, and identify an ultrasonic sensor closest to the user. The controller 140 may identify the position of the user based on a position of the ultrasonic sensor closest to the user.

In a third operation (S330), the door corresponding to the position of the user may be opened.

The controller 140 may control the door driver 160 to open a door corresponding to a position closest to the position of the user.

Hereinafter, the door control method according to the present disclosure will be described in more detail as follows.

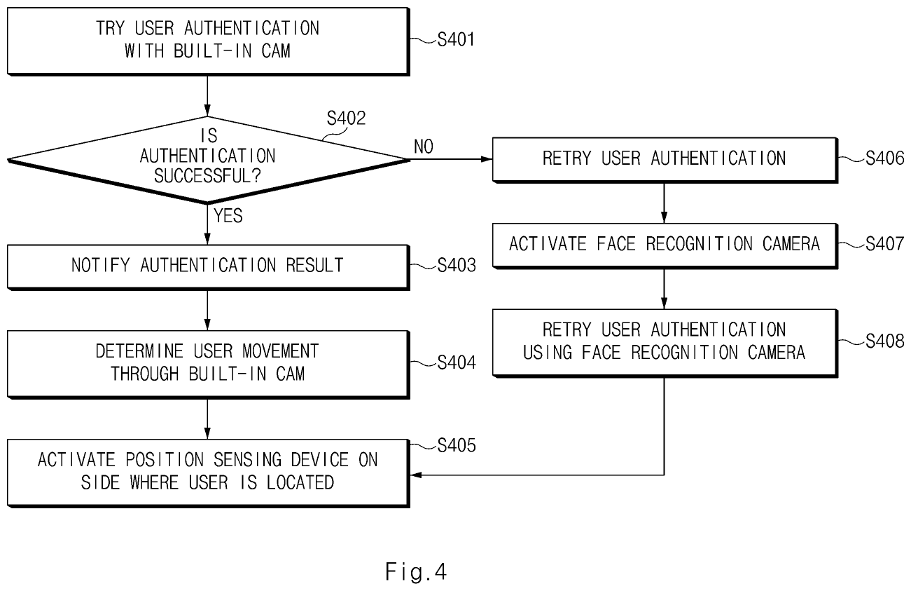

FIG. 4 is a flowchart illustrating a method for activating a position sensing device according to an embodiment of the present disclosure. Referring to FIG. 4, the method for activating the position sensing device according to an embodiment of the present disclosure will be described as follows.

In S401, the controller 140 may try the user authentication with the built-in cam BC.

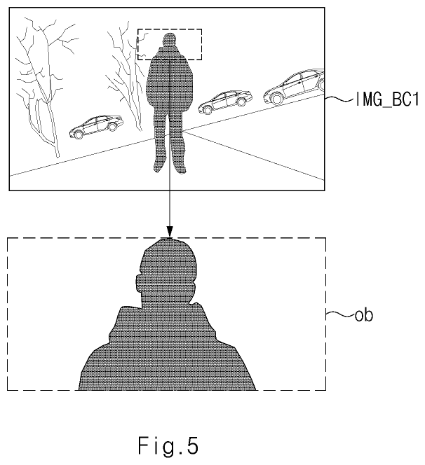

FIG. 5 is a view for illustrating a method for trying user authentication based on an exterior image acquired from a built-in cam. As shown in FIG. 5, the controller 140 may extract an object ob corresponding to a person from an exterior image IMG_BC1 acquired through the built-in cam BC. In particular, the controller 140 may extract a facial region of the person as the object ob.

According to one embodiment, the controller 140 may perform the user authentication by determining whether the object ob corresponds to a pre-stored user image. That is, the controller 140 may determine a degree of matching between the facial image of the object ob and the pre-stored user image, and complete the user authentication when the degree of matching is equal to or higher than a preset threshold.

According to another embodiment, the controller 140 may perform the user authentication by determining a gesture of the object ob and determining whether the gesture of the object corresponds to a pre-stored pattern.

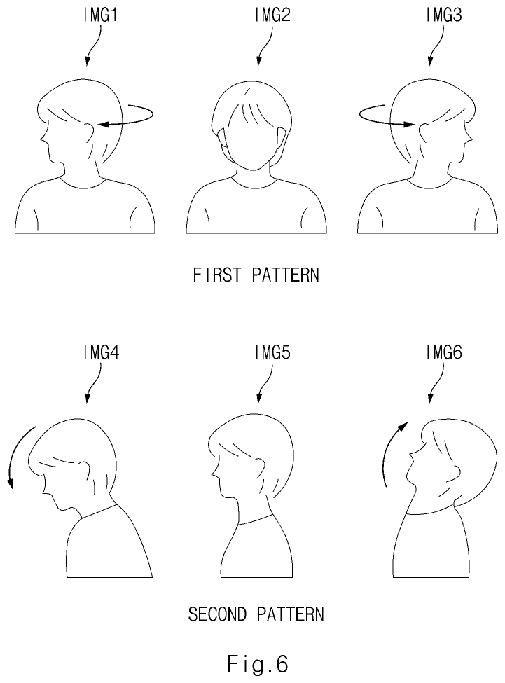

FIG. 6 is a view for illustrating an embodiment of performing user authentication based on a gesture of an object. As shown in FIG. 6, the controller 140 may determine the gesture of the object. For example, the controller 140 may detect a gesture of a first pattern in which the user shakes a head thereof based on consecutive first to third images IMG1 to IMG3. Alternatively, the controller 140 may detect a gesture of a second pattern in which the user nods the head thereof based on consecutive fourth to sixth images IMG4 to IMG6. The controller 140 may perform the user authentication based on the number of repetitions of the first pattern or the number of repetitions of the second pattern.

The embodiment of performing the user authentication based on the gesture of the object ob may be additionally performed after the user authentication performed based on the degree of matching of the facial image of the object ob.

Alternatively, instead of the user authentication performed based on the degree of matching of the facial image of the object ob, the user authentication may be performed based on the gesture of the object ob. Accordingly, the controller 140 may extract a hand or other body parts as the object in addition to the facial region of the person.

In S402 and S403, when the user authentication is successful based on the exterior image acquired with the built-in cam BC, the controller 140 may notify the user authentication result through the output device 150.

According to the embodiment, the controller 140 may notify that the user authentication is successful using the light emission of the lamp 151, and the number of light emission or a light emission pattern of the lamp 151 notifying the user authentication success may be set in advance.

According to another embodiment, the controller 140 may notify that the user authentication is successful using the ringing of the bri77er 152, and the number of ringing or a ringing pattern of the bri77er 152 notifying the user authentication success may be set in advance.

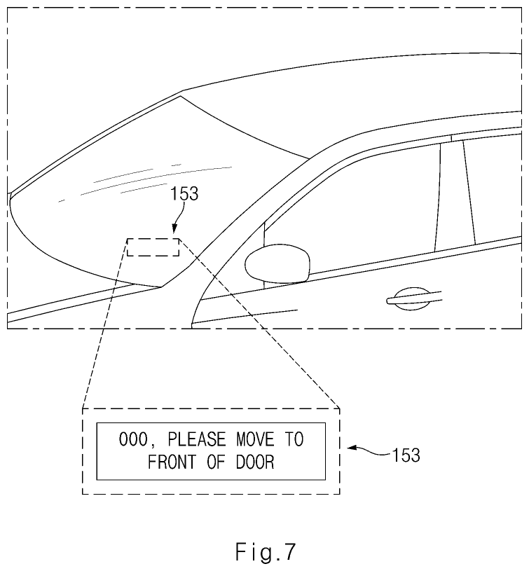

According to another embodiment, the controller 140 may notify that the user authentication is successful through the external display 153. FIG. 7 is a view illustrating an embodiment of notifying that user authentication is successful through an external display. As shown in FIG. 7, the controller 140 may request a user action for a next procedure while notifying that the user authentication is successful through the external display 153.

In S404, the controller 140 may determine a user movement based on the exterior image acquired through the built-in cam BC.

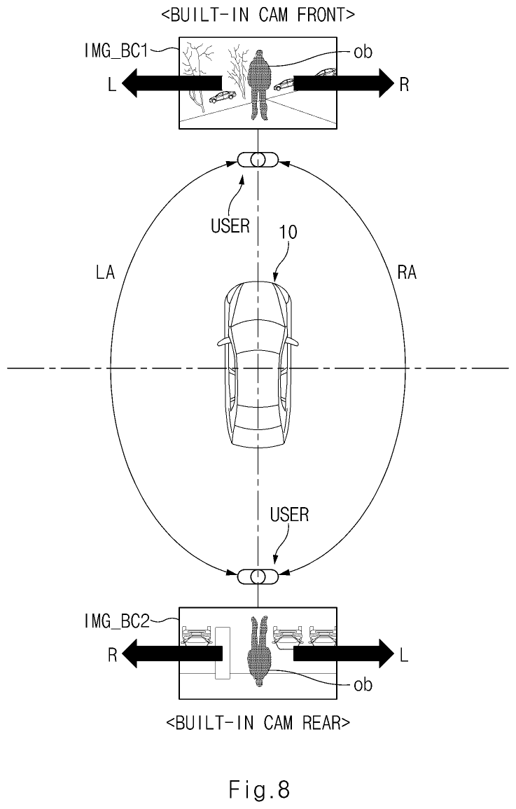

FIG. 8 is a view for illustrating a method for determining a user movement.

Referring to FIG. 8, the controller 140 may detect the object ob corresponding to a user USER from the first exterior image IMG_BC1 acquired through the first built-in cam BC. The controller 140 may acquire the first exterior images IMG_BC1 consecutive in a time series, and identify a moving direction of the object ob based on the consecutive first exterior images IMG_BC1. For example, when the object ob moves in a left direction “L” in the first exterior images IMG_BC1, the controller 140 may determine that the user USER moves to a left region LA of a vehicle 10.

Alternatively, the controller 140 may detect the object ob corresponding to the user USER from a second exterior image IMG_BC2 acquired through the second built-in cam BC.

The controller 140 may acquire the second exterior images IMG_BC2 consecutive in the time series, and identify the moving direction of the object ob based on the consecutive second exterior images IMG_BC2. For example, when the object ob moves in a right direction RA in the second exterior images IMG_BC2, the controller 140 may determine that the user USER moves to a right region RA of the vehicle 10.

In S405, the controller 140 may activate the position sensing device 120 on a side where the user is located.

According to the embodiment, when it is determined that the user moves to the left region LA, the controller 140 may activate the first to sixth ultrasonic sensors U1 to U6 shown in FIG. 1. In addition, when it is determined that the user moves to the right region RA, the controller 140 may activate the seventh to twelfth ultrasonic sensors U7 to U12 shown in FIG. 1.

According to another embodiment, when it is determined that the user moves to the left region LA, the controller 140 may activate the first side view monitoring camera SVM1 shown in FIG. 1. In addition, when it is determined that the user moves to the right region RA, the controller 140 may activate the second side view monitoring camera SVM2 shown in FIG. 1.

When the user authentication has failed based on the exterior image acquired with the built-in cam BC in S402, in S406, the controller 140 may request user authentication retry.

The controller 140 may notify the user authentication failure through the output device 150.

According to the embodiment, the controller 140 may notify that the user authentication has failed using the light emission of the lamp 151. The number of light emission or a light emission pattern of the lamp 151 notifying the user authentication failure may be set in advance.

According to another embodiment, the controller 140 may notify that the user authentication has failed using the ringing of the bri77er 152, and the number of ringing or a ringing pattern of the bri77er 152 notifying the user authentication failure may be set in advance.

According to another embodiment, the controller 140 may notify that the user authentication has failed through the external display 153. When notifying the user authentication failure through the external display 153, the controller 140 may guide the user to retry the user authentication through the face recognition camera FC to proceed to operation S407.

In S407, the controller 140 may activate the face recognition camera FC. The controller 140 may activate the face recognition camera FC when the user authentication has failed.

In S408, the controller 140 may perform the user authentication retry using the face recognition camera FC. The controller 140 may acquire the exterior image through the face recognition camera FC, and perform the user authentication based on the exterior image. A method for performing the user authentication with the image acquired through the face recognition camera FC may be the same as the method for performing the user authentication with the image acquired through the built-in cam BC. That is, the controller 140 may perform the user authentication by determining whether the object ob corresponds to the pre-stored user image. Alternatively, the controller 140 may perform the user authentication by determining the gesture of the object ob and determining whether the gesture of the object corresponds to the pre-stored pattern.

After S408, the controller 140 may proceed with an operation of activating the position sensing device on the side where the user is located corresponding to operation S405. A user position determined based on S408 may be a position at which the face recognition camera FC that has acquired the image from which the object was detected in the user authentication retry process is disposed.

For example, when the object is detected from an image acquired through the first face recognition camera FC1 in S408, the user may be located in the left region of the vehicle. Accordingly, the controller 140 may activate the first to sixth ultrasonic sensors U1 to U6 located in the left region or activate the first side view monitoring camera SVM1.

For example, when the object is detected from an image acquired through the second face recognition camera FC2 in S408, the user may be located in the right region of the vehicle. Accordingly, the controller 140 may activate the seventh to twelfth ultrasonic sensors U7 to U12 located in the right region or the second side view monitoring camera SVM2.

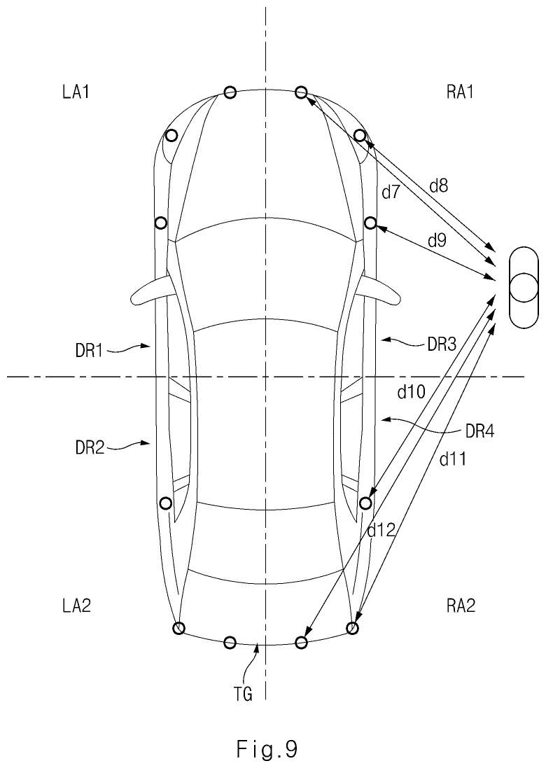

FIG. 9 is a view for illustrating an embodiment of determining a position of a user. FIG. 9 illustrates operation S320 shown in FIG. 3, and illustrates an embodiment in which the user is located in the right region of the vehicle.

Referring to FIG. 9, the controller 140 may determine the position of the user based on the ultrasonic sensors U. The controller 140 may activate the seventh to twelfth ultrasonic sensors U7 to U12 based on that the user USER is located in the right region RA of the vehicle 10. In addition, the controller 140 may calculate distances between the ultrasonic sensors and the user USER based on an arrival time of a reflected wave received by the ultrasonic sensors U. For example, the controller 140 may calculate d7 corresponding to a distance between the seventh ultrasonic sensor U7 and the user USER. Similarly, the controller 140 may calculate d8 to d12.

The controller 140 may measure a third reference distance between the ultrasonic sensors U7 to U9 corresponding to the third door DR3 and the user USER, a fourth reference distance between the ultrasonic sensors U corresponding to the fourth door DR4 and the user USER, and a rear reference distance between the ultrasonic sensors U10 and U11 corresponding to the tailgate TG and the user USER.

A method for calculating a reference distance based on an embodiment in which, among the ultrasonic sensors of the right region RA, the seventh to ninth ultrasonic sensors U7 to U9 correspond to the third door DR3, the tenth and eleventh ultrasonic sensors U10 and U11 correspond to the fourth door DR4, and the twelfth ultrasonic sensor U12 corresponds to the tailgate TG is as follows.

The reference distance may be an average distance of the distances between the user USER and the respective ultrasonic sensors. Alternatively, when there is only one ultrasonic sensor corresponding to the door, the reference distance may be a distance between the user USER and the corresponding ultrasonic sensor.

That is, a third reference distance D_dr3 may be calculated as D_dr3=(d7+d8+d9)/3, and a fourth reference distance D_dr4 may be calculated as D_dr4=(d10+d11)/2. When the ultrasonic sensors of the right region RA are activated, a rear reference distance D_tg may be d12.

The controller 140 may calculate the smallest reference distance among the third reference distance D_dr3, the fourth reference distance D_dr4, and the rear reference distance D_tg, and determine a region corresponding to the corresponding reference distance as the position of the user. For example, by the user USER shown in FIG. 9, the controller 140 may determine that the third reference distance D_dr3 is the smallest, and may determine that the user USER is located in a right first region RA1.

After determining the position of the user through operation of S320 as such, the controller 140 may open the door through operation S330 shown in FIG. 3. That is, the controller 140 may control the door driver 160 to open the third door DR3 corresponding to the right first region RA1 in the embodiment shown in FIG. 9.

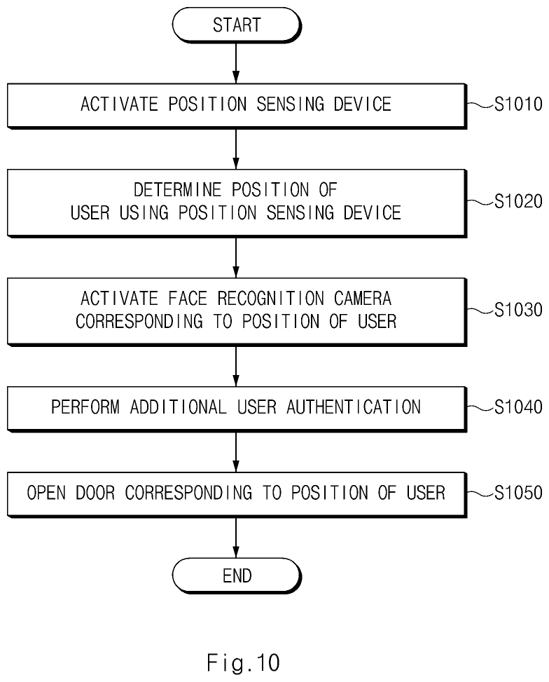

FIG. 10 is a flowchart illustrating a door control method according to another embodiment of the present disclosure.

Referring to FIG. 10, the door control method according to another embodiment of the present disclosure may activate the position sensing device in S1010, and determine the position of the user using the position sensing device in S1020. S1010 to S1020 may be the same procedures as S310 to S320 shown in FIG. 3.

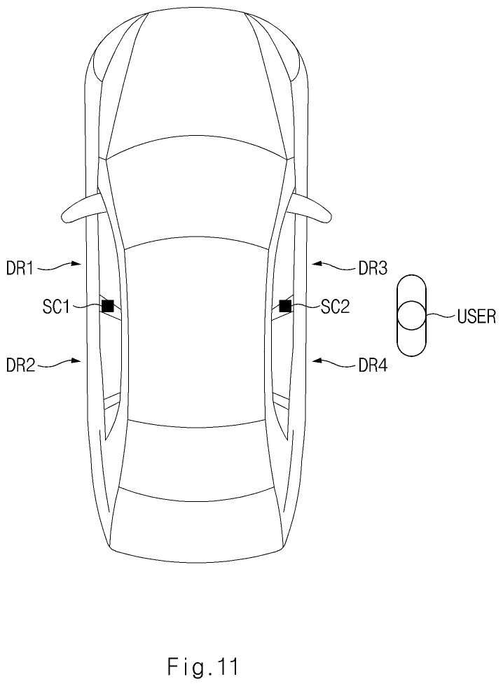

In S1030, the controller 140 may activate the face recognition camera corresponding to the position of the user. For example, when the user USER is located in the right first region RA1 as shown in FIG. 9, the controller 140 may activate the second face recognition camera FC2 located in the right region as shown in FIG. 11.

In S1040, the controller 140 may perform additional user authentication. The additional user authentication may be an operation of supplementing the user authentication performed based on the built-in cam BC in S1010.

The operation of performing the additional user authentication may include an operation of guiding the additional user authentication through the output device 150. For example, the controller 140 may request the additional user authentication using the light emission of the lamp 151 or the ringing of the buzzer 152. Alternatively, the controller 140 may request the additional user authentication through the external display 153.

FIG. 11 is a view for illustrating an additional user authentication procedure. As shown in FIG. 11, the additional user authentication procedure may be performed by detecting the object corresponding to the user USER from the image acquired through the second face recognition camera FC2 and performed based on a shape or a gesture of the object.

In S1050, after the additional user authentication is completed, the controller 140 may open the door corresponding to the position of the user USER. The operation of opening the door in S1050 may refer to the user position determined in operation S1020. Accordingly, in response to the user position determined as the right first region RA1 in FIG. 9, the controller 140 may open the first door DR1.

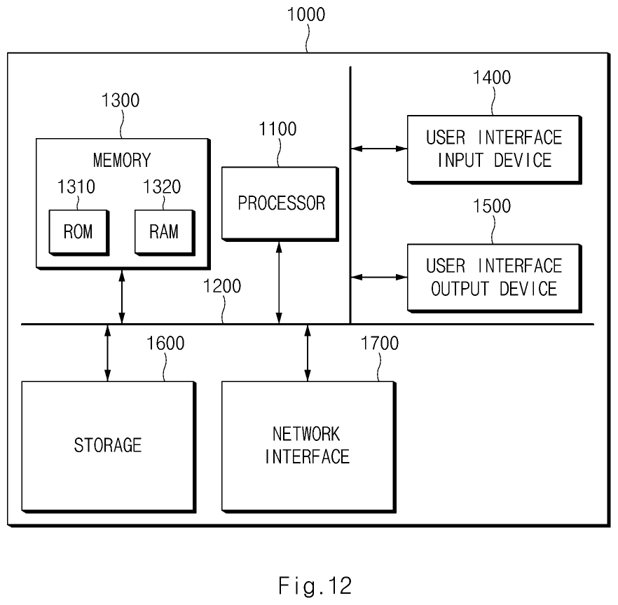

FIG. 12 is a diagram illustrating a computing system according to an embodiment of the present disclosure.

Referring to FIG. 12, a computing system 1000 may include at least one processor 1100, a memory 1300, a user interface input device 1400, a user interface output device 1500, storage 1600, and a network interface 1700 connected via a bus 1200.

The processor 1100 may be a central processing unit (CPU) or a semiconductor device that performs processing on commands stored in the memory 1300 and/or the storage 1600. In particular, the processor 1100 may include the controller 140 of the door control device 100 shown in FIG. 2. The memory 1300 and the storage 1600 may include various types of volatile or non-volatile storage media. For example, the memory 1300 may include a ROM (Read Only Memory) and a RAM (Random Access Memory).

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EFPROM, a register, a hard disk, a removable disk, and a CD-ROM.

The exemplary storage medium is coupled to the processor 1100, which may read information from, and write information to, the storage medium. In another method, the storage medium may be integral with the processor 1100. The processor and the storage medium may reside within an application specific integrated circuit (ASIC). The ASIC may reside within the user terminal. In another method, the processor and the storage medium may reside as individual components in the user terminal.

The description above is merely illustrative of the technical idea of the present disclosure, and various modifications and changes may be made by those skilled in the art without departing from the essential characteristics of the present disclosure.

Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the embodiment of the present disclosure, because the doors other than the door desired by the user are not opened while remotely adjusting the door of the vehicle, the user safety may be ensured while maintaining convenience of the user.

In addition, according to the embodiment of the present disclosure, because the door is controlled based on the user authentication based on the image, the user may easily open the door desired by the user even when the both hands are not free because of carrying the stuff or the like, thereby more easily moving the stuff into the vehicle.

In addition, various effects that are directly or indirectly identified through the present document may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling a door of a vehicle, the device comprising:
a position sensing device configured to sense an object outside the vehicle;
an authentication camera configured to perform the user authentication; and
a controller configured to:
activate the position sensing device based on user authentication;
determine a position of a user when the object sensed by the position sensing device is the user; and
open a door of the vehicle corresponding to the position of the user.

2. The device of claim 1, wherein the authentication camera comprises a first authentication camera configured to acquire an exterior image of the vehicle at regular intervals to perform the user authentication.

3. The device of claim 2, wherein the controller is further configured to:
extract the object from the exterior image acquired through the first authentication camera; and
determine whether the object corresponds to a pre-stored user image.

4. The device of claim 2, wherein the controller is further configured to:
determine a gesture of the object based on the consecutive exterior images; and
determine whether the gesture corresponds to a pre-stored pattern.

5. The device of claim 2, wherein the controller is further configured to:
determine a movement of the user based on the consecutive exterior images; and
activate the position sensing device located on a side where the user has moved to.

6. The device of claim 2, the authentication camera comprises a second authentication camera for retrying the user authentication when the user authentication fails, and
wherein the second authentication camera is disposed in a direction perpendicular to a direction of the first authentication camera.

7. The device of claim 6, wherein the second authentication camera is configured to be located on a side of the vehicle,
wherein the controller is further configured to activate the position sensing device positioned on the same side as the second authentication camera performed the user authentication retry.

8. The device of claim 1, wherein the position sensing device comprises ultrasonic sensors corresponding to each of one or more doors of a vehicle.

9. The device of claim 1, wherein the position sensing device is a side view monitoring camera of the vehicle.

10. The device of claim 2, wherein the controller is further configured to open a door of the vehicle after performing additional user authentication using a second authentication camera disposed in a direction perpendicular to a direction of the first authentication camera.

11. A method for controlling a door of a vehicle, the method comprising:
activating a position sensing device based on user authentication;
determining a position of a user located outside the vehicle using the activated position sensing device; and
opening a door of the vehicle corresponding to the position of the user.

12. The method of claim 11, wherein the activating of the position sensing device comprises:
acquiring an exterior image of the vehicle at regular intervals; and
performing the user authentication based on an object extracted from the exterior image.

13. The method of claim 12, wherein the performing of the user authentication comprises:
determining whether the object corresponds to a pre-stored user image.

14. The method of claim 12, wherein the performing of the user authentication comprises:
determining a gesture of the object; and
determining whether the gesture of the object corresponds to a pre-stored pattern.

15. The method of claim 12, wherein the activating of the position sensing device comprises:
determining a movement of the user based on the consecutive exterior images; and
activating the position sensing device located on a side where the user has moved to.

16. The method of claim 12, wherein the performing of the user authentication comprises:
trying the user authentication based on the exterior image acquired through a first authentication camera disposed in a front direction of the vehicle; and
retrying the user authentication using a second authentication camera located on a side of the vehicle when the user authentication fails.

17. The method of claim 16, wherein the activating of the position sensing device comprises:
activating the position sensing device positioned on the same side as the second authentication camera acquired the image where the object is detected in the user authentication retry procedure.

18. The method of claim 11, wherein the determining of the position of the user comprises:
using one or more ultrasonic sensor corresponding to one or more doors of the vehicle and/or a side view monitoring camera of the vehicle.

19. The method of claim 11, wherein the opening of the door comprises:
performing the user authentication using a first authentication camera disposed in a first direction of the vehicle;
performing additional user authentication using a second authentication camera disposed in a direction perpendicular to the direction of the first authentication camera; and
opening the door based on the additional user authentication.

20. A vehicle comprising a device of claim 1.
